(19) United States
(12) Patent Application Publication
(10) Pub. No.: US 2010/0086827 A1
(43) Pub. Date: Apr. 8, 2010

(54) GAS-LIQUID SEPARATION DEVICE AND FUEL CELL SYSTEM

(76) Inventor: Koji Katano, Aichi-ken (JP)

Correspondence Address: KENYON & KENYON LLP, 1500 K STREET N.W., SUITE 700, WASHINGTON, DC, 20005, US

(21) Appl. No.: 12/531,268

(22) PCT Filed: Oct. 23, 2008
(86) PCT No.: PCT/JP2008/069700

§ 371 Date: Sep. 14, 2009

(30) Foreign Application Priority Data
Nov. 5, 2007 (JP) 2007-287642

(51) Int. Cl. H01M 2/00; F02M 17/20; F02M 37/04

(52) U.S. Cl. 429/34; 261/119.2; 261/29

(57) ABSTRACT

A gas-liquid separation device is used in a fuel cell system including fuel cells. The gas-liquid separation device includes: a separator configured to separate a fuel gas after an electrochemical reaction performed in the fuel cells from liquid water flowing with the fuel gas; and a reservoir configured to allow accumulation of the liquid water discharged from the fuel cells. The gas-liquid separation device also has a fluid outflow path arranged to connect with a connection object member and have a fluid outlet formed to be open in a vertical direction. The fluid outflow path is configured to flow out a fluid from inside of the gas-liquid separation device to the connection object member via the fluid outlet. The fluid outlet is provided to differ in position in a direction perpendicular to a vertical direction from the separator and the reservoir.

### TECHNICAL FIELD

The present invention relates to a gas-liquid separation device used in a fuel cell system including fuel cells.

### BACKGROUND ART

As is known in the art, the fuel cell system is equipped with a gas-liquid separation device configured to separate a fuel gas after an electrochemical reaction performed in the fuel cells from liquid water flowing with the fuel gas and to allow accumulation of the liquid water therein.

For the purpose of size reduction, the fuel cell system is generally required to have an intensive arrangement where various devices used for the operations of the fuel cell system are located in a limited space. This limited space may make it difficult to ensure a working space for connecting the gas-liquid separation device with a connection object member. Namely there may be an insufficient tool-manipulation space to have difficulty in using a required tool for connection. The connection object member is, for example, a pump, a valve, or fuel cells included in the fuel cell system.

### SUMMARY OF THE INVENTION

By taking into account the problem of the prior art discussed above, there would thus be a demand for ensuring a tool-manipulation space to readily connect a gas-liquid separation device with a connection object member.

The present invention accomplishes at least part of the demand mentioned above and the other relevant demands by variety of configurations and arrangements discussed below.

According to a first aspect, the invention is directed to a gas-liquid separation device used in a fuel cell system including fuel cells. The gas-liquid separation device according to the first aspect of the invention includes: a separator configured to separate a fuel gas after an electrochemical reaction performed in the fuel cells from water discharged with the fuel gas from the fuel cells; a reservoir configured to allow accumulation of the water discharged from the fuel cells; and a fluid outflow path arranged to connect the gas-liquid separation device with a connection object member, which is used in connection with the gas-liquid separation device, and have a fluid outlet formed to be open in a vertical direction and to differ in position in a direction perpendicular to the vertical direction from the separator and the reservoir. The fluid outflow path is configured to flow out a fluid from inside of the gas-liquid separation device to the connection object member via the fluid outlet.

The gas-liquid separation device according to the first aspect of the invention effectively ensures a tool-manipulation space to readily connect the gas-liquid separation device with the connection object member.

In one preferable application of the gas-liquid separation device according to the first aspect of the invention, the fluid outflow path is constructed to function as a fuel gas outflow path and cause the fuel gas separated by the separator to be flowed out as the fluid upward in the vertical direction from the separator. The fluid outlet is formed to be open upward in the vertical direction and to function as a fuel gas outlet connecting with the connection object member. This arrangement ensures the tool-manipulation space to readily connect the connection object member with the fuel gas outflow path.

In one preferable embodiment of the gas-liquid separation device of this application, the fuel cell system includes: a fuel gas supply conduit arranged to supply the fuel gas to the fuel cells; and a pump arranged to recirculate the fuel gas, which is introduced into the gas-liquid separation device, to the fuel gas supply conduit for reuse. The fuel gas outlet of the fuel gas outflow path is connected with the pump functioning as the connection object member. This arrangement ensures the tool-manipulation space to readily connect the pump with the fuel gas outflow path.

In one preferable embodiment according to the first aspect of the invention, the gas-liquid separation device further has: a fuel gas inlet formed to cause the fuel gas after the electrochemical reaction performed in the fuel cells to be introduced into the separator; and an exhaust outlet formed to cause the accumulated water in the reservoir to be discharged out of the gas-liquid separation device. The fuel gas inlet and the exhaust outlet are arranged such as to make an inflow direction of the fuel gas via the fuel gas inlet into the gas-liquid separation device opposite to an outflow direction of the accumulated water via the exhaust outlet. This arrangement desirably prevents vortexes from being generated in the accumulated water discharged via the exhaust outlet, thus improving the water discharge property of the accumulated water via the exhaust outlet.

In another preferable application of the gas-liquid separation device according to the first aspect of the invention, the fluid outflow path is constructed as an exhaust flow path arranged to discharge the accumulated water in the reservoir downward in the vertical direction from the reservoir. The fluid outlet is formed to be open downward in the vertical direction and to function as an exhaust outlet connecting with the connection object member. This arrangement ensures the tool-manipulation space to readily connect the connection object member with the exhaust flow path.

In another preferable embodiment according to the first aspect of the invention, the connection object member is designed to have a first flange provided at a connection structure of connecting the connection object member with the fluid outlet. The gas-liquid separation device further has a second flange provided at the fluid outlet of the fluid outflow path. The connection object member is connected with the fluid outlet by fastening the first flange to the second flange with a clamp bolt. This arrangement enables the connection object member to be securely connected with the fluid outlet.

According to a second aspect, the invention is also directed to a gas-liquid separation device used in a fuel cell system including fuel cells. The gas-liquid separation device according to the second aspect of the invention includes: a separator configured to separate a fuel gas after an electrochemical reaction performed in the fuel cells from water discharged with the fuel gas from the fuel cells; a reservoir configured to allow accumulation of the water discharged from the fuel cells; and a hollow column extended to pass through either the separator or the reservoir and formed to have a hollow section connecting with outside of the gas-liquid separation device and a connection structure arranged on an extension of the hollow section to connect the gas-liquid separation device with a connection object member.

In the gas-liquid separation device according to the second aspect of the invention, the hollow section of the hollow column is used as a tool-manipulation space to readily connect the gas-liquid separation device with the connection object member.

In one preferable embodiment according to the second aspect of the invention, the gas-liquid separation device further has a fuel gas outflow path arranged to make the fuel gas separated by the separator flow out of the separator and formed to have a fuel gas outlet connecting with the connection object member. The hollow column is provided to locate a connection structure of connecting the fuel gas outlet of the fuel gas outflow path with the connection object member on the extension of the hollow section. This arrangement ensures the tool-manipulation space to readily connect the connection object member with the fuel gas outflow path.

In one preferable application of the gas-liquid separation device of this embodiment, the fuel gas outflow path is arranged to flow out the fuel gas upward in a vertical direction from the separator, and the fuel gas outlet is formed to be open upward in the vertical direction. The hollow column is extended to pass through either the separator or the reservoir in the vertical direction. This arrangement ensures the tool-manipulation space to readily connect the connection object member with the fuel gas outflow path formed upward in the vertical direction.

In one preferable structure of the above embodiment according to the second aspect of the invention, the connection object member is designed to have a first flange provided at the connection structure of connecting the connection object member with the fuel gas outlet. The gas-liquid separation device further has a second flange provided at the fuel gas outlet of the fuel gas outflow path. The connection object member is connected with the fuel gas outlet by fastening the first flange to the second flange with a clamp bolt. The hollow column is arranged to locate the clamp bolt on the extension of the hollow section. This arrangement ensures the tool-manipulation space to readily connect the first flange with the second flange.

In another preferable embodiment according to the second aspect of the invention, the gas-liquid separation device further has an exhaust flow path arranged to cause the accumulated water in the reservoir to be discharged from the reservoir and formed to have an exhaust outlet connecting with the connection object member. The hollow column is provided to locate a connection structure of connecting the exhaust outlet of the exhaust flow path with the connection object member on the extension of the hollow section. This arrangement ensures the tool-manipulation space to readily connect the connection object member with the exhaust flow path.

In one preferable structure of this embodiment according to the second aspect of the invention, the connection object member is designed to have a first flange provided at a connection structure of connecting the connection object member with the exhaust outlet. The gas-liquid separation device further has a second flange provided at the exhaust outlet of the fuel gas outflow path. The connection object member is connected with the exhaust outlet by fastening the first flange to the second flange with a clamp bolt. The hollow column is formed to locate the clamp bolt on the extension of the hollow section. This arrangement ensures the tool-manipulation space to readily connect the first flange with the second flange.

In still another preferable embodiment according to the second aspect of the invention, the gas-liquid separation device further has a fuel gas inlet formed to cause the fuel gas after the electrochemical reaction performed in the fuel cells to be introduced into the separator. The hollow column is provided to locate a connection structure of connecting the fuel gas inlet with the connection object member on the extension of the hollow section. This arrangement ensures the tool-manipulation space to readily connect the connection object member with the fuel gas inlet.

In one preferable structure of this embodiment according to the second aspect of the invention, the connection object member is designed to have a first flange provided at a connection structure of connecting the connection object member with the fuel gas inlet. The gas-liquid separation device further has a second flange provided at the fuel gas inlet. The connection object member is connected with the fuel gas inlet by fastening the first flange to the second flange with a clamp bolt. The hollow column is formed to locate the clamp bolt on the extension of the hollow section. This arrangement ensures the tool-manipulation space to readily connect the first flange with the second flange.

In one preferable application of the gas-liquid separation device according to the second aspect of the invention, the second flange is designed to have an insertion structure formed to receive the clamp bolt inserted therein. The hollow column is connected with the second flange, and the hollow section of the hollow tube communicates with the insertion structure of the second flange. This arrangement effectively prevents a tool from being misaligned from the clamp bolt.

In another preferable application of the gas-liquid separation device according to the second aspect of the invention, the second flange is designed to have an insertion structure formed to receive the clamp bolt inserted therein. The insertion structure is formed to be open in a thickness direction of the second flange, as well as in a direction perpendicular to the thickness direction. This arrangement enables the clamp bolt to be readily located at a desired fastening position, thus improving the assembling property of the flange with the clamp bolt.

In one preferable structure of the gas-liquid separation device of the above application, the second flange is designed to have at least two insertion structures. The insertion structures are formed to be open in the thickness direction of the second flange, as well as in the direction perpendicular to the thickness direction and are arranged to have an identical opening orientation in the direction perpendicular to the thickness direction. This arrangement enables the multiple clamp bolts to be quickly and readily located at desired fastening positions, thus improving the assembling property of the flange with the clamp bolt.

In still another preferable application of the gas-liquid separation device according to the second aspect of the invention, the hollow section of the hollow column is formed to have an inner diameter that is greater than an outer diameter of the clamp bolt. This arrangement facilitates insertion of a tool required for fastening the clamp bolt into the hollow column, thus improving the assembling property.

In another preferable application of the gas-liquid separation device according to the second aspect of the invention, the connection object member is a pump. In the case of connection of a relatively large-sized pump with a specific portion of the gas-liquid separation device, the hollow section of the hollow column is used as the tool-manipulation space to readily connect the pump with the gas-liquid separation device.

According to a third aspect, the invention is further directed to a fuel cell system. The fuel cell system according to the third aspect of the invention includes the gas-liquid separation device according to the first aspect of the invention or the gas-liquid separation device according to the second aspect of the invention. The fuel cell system according to the third aspect of the invention ensures a tool-manipulation space to readily connect a specific portion of the gas-liquid separation device with the connection object member.

The technique of the invention is not restricted to the gas-liquid separation device having any of the arrangements discussed above or the fuel cell system including the gas-liquid separation device but may also be actualized by diversity of other device applications including a fluid outflow path provided in the gas-liquid separation device, as well as by diversity of method applications including a control method of the fuel cell system.

### BRIEF DESCRIPTION OF THE DRAWINGS

FIG. 1 is a block diagram illustrating the schematic configuration of a fuel cell system in a first embodiment of the invention;

FIG. 2 is a view schematically showing a cross section and periphery of a gas-liquid separation device;

FIG. 3 is a view showing the gas-liquid separation device of FIG. 2 seen in a z-direction;

FIG. 4 is a view schematically showing a cross section and periphery of a gas-liquid separation device in a second embodiment;

FIG. 5 is a view showing the gas-liquid separation device of FIG. 4 seen in the z-direction;

FIG. 6 is a view schematically showing a cross section and periphery of a gas-liquid separation device in a third embodiment;

FIG. 7 is a view showing the gas-liquid separation device of FIG. 6 seen in the z-direction;

FIG. 8 is a view schematically showing a cross section and periphery of a gas-liquid separation device in a fourth embodiment;

FIG. 9 is a sectional view showing a D-D cross section of the gas-liquid separation device of FIG. 8;

FIG. 10 is a view schematically showing a cross section and periphery of a gas-liquid separation device in a fifth embodiment;

FIG. 11 is a view schematically showing a cross section and periphery of a gas-liquid separation device in a modified example 1; and

FIG. 12 is views showing modified structures of a flange.

### DETAILED DESCRIPTION OF THE PREFERRED EMBODIMENTS

Some modes of carrying out the invention are described below as preferred embodiments with reference to the accompanied drawings.

### A. First Embodiment

### A1. Configuration of Fuel Cell System 1000

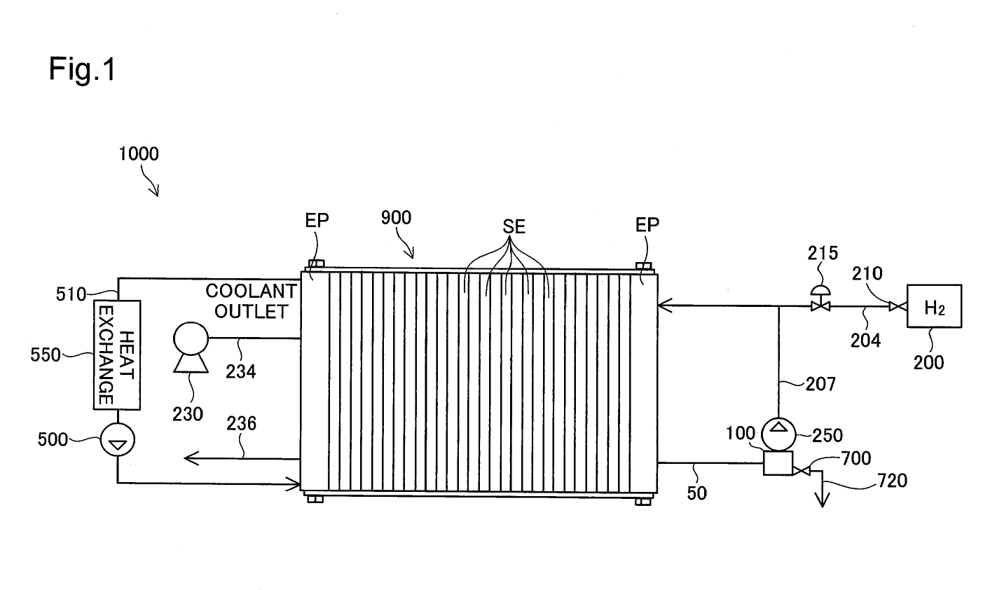

FIG. 1 is a block diagram illustrating the schematic configuration of a fuel cell system 1000 in a first embodiment of the invention. The fuel cell system 1000 of the embodiment mainly includes a fuel cell stack 900, a hydrogen tank 200, a hydrogen cutoff valve 210, a regulator 215, a compressor 230, a hydrogen circulation pump 250, a coolant circulation pump 500, a radiator 550, a gas-liquid separation device 100, and a purge valve 700.

The fuel cell stack 900 includes relatively small-sized polymer electrolyte fuel cells having high power generation efficiency. The fuel cell stack 900 has a stack structure formed by holding multiple fuel cells SE between a pair of end plates EP.

Each fuel cell SE has a membrane electrode assembly (not shown), an anode separator (not shown), and a cathode separator (not shown). The membrane electrode assembly has an electrolyte membrane (not shown), a cathode (not shown) and an anode (not shown) as electrodes, and gas diffusion layers (not shown). The electrolyte membrane with the cathode and the anode formed on the respective faces thereof is placed between the gas diffusion layers to give the membrane electrode assembly. The fuel cell SE is constructed by further interposing the membrane electrode assembly between the anode separator and the cathode separator.

The hydrogen tank 200 is a container for storage of high-pressure hydrogen gas and is connected to the fuel cell stack 900 via a fuel gas supply conduit 204. The hydrogen cutoff valve 210 and the regulator 215 are arranged on the fuel gas supply conduit 204 in this sequence closer to the hydrogen tank 200. Hydrogen gas is supplied as a fuel gas to the fuel cell stack 900 by opening the hydrogen cutoff valve 210.

The regulator 215 regulates the pressure of the fuel gas supplied to the fuel cell stack 900 according to the operating conditions of the fuel cell system 1000.

The compressor 230 is connected with the fuel cell stack 900 via an oxidizing gas supply conduit 234 to compress the air and supply the compressed air as an oxidizing gas to the cathodes of the fuel cell stack 900. The fuel cell stack 900 is further connected with an oxidizing gas exhaust conduit 236 to discharge the oxidizing gas after the electrochemical reaction at the cathodes out of the fuel cell system 1000 via the oxidizing gas exhaust conduit 236.

The fuel cell stack 900 is also connected with a coolant circulation path 510. The coolant circulation pump 500 and the radiator 550 are provided on the coolant circulation path 510. The radiator 550 cools down the flow of a coolant, which is warmed by the heat evolved from the fuel cell stack 900. The coolant circulation pump 500 recirculates the flow of the coolant cooled down by the radiator 550 to the fuel cell stack 900. This arrangement enables the fuel cell stack 900 to be continuously cooled down by the flow of the coolant.

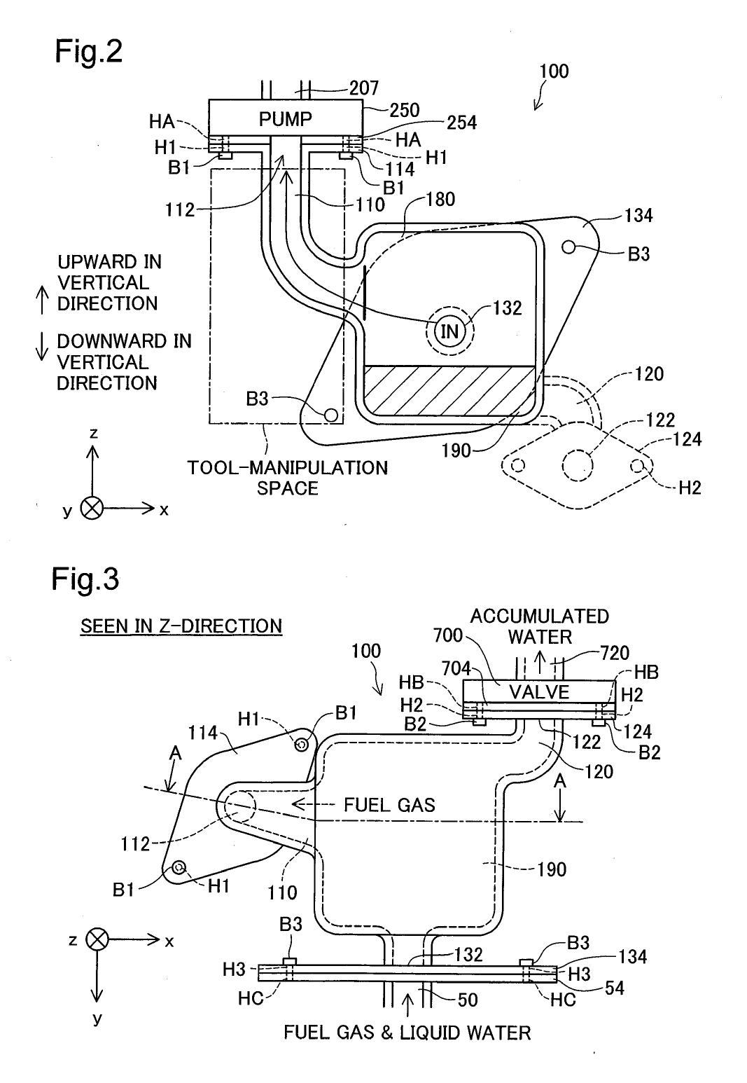

FIG. 2 schematically shows a cross section and periphery of the gas-liquid separation device 100. An x-direction, a y-direction, and a z-direction are respectively defined as a horizontal direction, a front-back direction, and a vertical direction in FIG. 2. An upward direction and a downward direction in the drawing of FIG. 2 represent upward in a vertical direction (z-direction) and downward in the vertical direction (direction opposite to the z-direction). FIG. 3 shows the gas-liquid separation device 100 of FIG. 2 seen in the z-direction. The cross section of the gas-liquid separation device 100 shown in FIG. 2 is equivalent to an A-A cross section of FIG. 3. The detailed structure of the gas-liquid separation device 100 is described below with reference to FIGS. 2 and 3.

The gas-liquid separation device 100 mainly includes a fuel gas inlet 132, a fuel gas outflow path 110, a gas discharge-water discharge flow path 120, a separator 180, a reservoir 190, and flanges 134, 114, and 124 as shown in FIGS. 2 and 3.

In the gas-liquid separation device 100, the flange 134 is provided at the fuel gas inlet 132. The flange 134 is fastened to a flange 54 provided in a fuel gas exhaust conduit 50 by means of clamp bolts B3 at two different positions. Such fixation connects the fuel gas inlet 132 with the fuel gas exhaust conduit 50 and thereby enables the fuel gas after the electrochemical reaction at the anodes of the fuel cell stack 900 to be introduced into the gas-liquid separation device 100. Each of the clamp bolts B3 is inserted through a bolt hole H3 formed in the flange 134 and a bolt hole HC formed in the flange 54.

The separator 180 is designed to separate the fuel gas after the electrochemical reaction (fuel off gas) introduced via the fuel gas inlet 132 from water (liquid water) discharged with the fuel off gas from the fuel cell stack 900. The reservoir 190 is designed to allow accumulation of the liquid water separated by the separator 180. In the description hereafter, the water accumulated in the reservoir 190 is referred to as ‘accumulated water’.

The fuel gas outflow path 110 is formed as a flow path of flowing out the fuel gas in the separator 180 toward the hydrogen circulation pump 250. As shown in FIGS. 2 and 3, the fuel gas outflow path 110 is protruded from the separator 180 in a direction opposite to the x-direction and is bent substantially upward in the vertical direction (z-direction). A fuel gas outlet 112 formed to be open upward in the vertical direction is provided at an end of the fuel gas outflow path 110. Namely the fuel gas outlet 112 is arranged on the fuel gas outflow path 110 to differ in position in a direction (in the direction opposite to the x-direction) perpendicular to the vertical direction (z-direction) from the separator 180 and the reservoir 190. The flange 114 is provided at the fuel gas outlet 112. The flange 114 is fastened with a flange 254 provided in the hydrogen circulation pump 250 by means of clamp bolts B1 at two different positions. Such fixation connects the fuel gas outlet 112 with the hydrogen circulation pump 250. Each of the clamp bolts B1 is inserted through a bolt hole H1 formed in the flange 114 and a bolt hole HA formed in the flange 254.

The fuel gas flowed out from the fuel gas outflow path 110 to the hydrogen circulation pump 250 goes through a gas circulation flow path 207 and is recirculated to the fuel gas supply conduit 204. The remaining hydrogen included in the fuel gas is accordingly recirculated and is reused for power generation. In one preferable application, an ion exchange unit may be provided at a connection of the gas-liquid separation device 100 with the fuel gas exhaust conduit 50 to remove ions contained in the liquid water discharged from the fuel cell stack 900.

The gas discharge-water discharge flow path 120 is formed as a flow path of discharging the accumulated water in the reservoir 190 and the fuel gas out of the gas-liquid separation device 100. As shown in FIGS. 2 and 3, the gas discharge-water discharge flow path 120 is protruded from the reservoir 190 in the x-direction in a gently inclined manner and is bent in a direction opposite to the y-direction in a gently inclined manner. An exhaust outlet 122 formed to be open in the direction opposite to the y-direction is provided at an end of the gas discharge-water discharge flow path 120. Namely the exhaust outlet 122 is arranged on the gas discharge-water discharge flow path 120 to differ in position in a direction (in the direction opposite to the y-direction) perpendicular to the vertical direction (z-direction) from the separator 180 and the reservoir 190. The flange 124 is provided at the exhaust outlet 122. The flange 124 is fastened to a flange 704 provided in the purge valve 700 by means of clamp bolts B2 at two different positions. Such fixation connects the exhaust outlet 122 with the purge valve 700. Each of the clamp bolts B2 is inserted through a bolt hole H2 formed in the flange 124 and a bolt hole HB formed in the flange 704.

The purge valve 700 is connected with an external outflow path 720. In an open position of the purge valve 700, the accumulated water inside the gas-liquid separation device 100 and the fuel gas having a relatively high concentration of impurities (for example, nitrogen) go through the gas discharge-water discharge flow path 120, the exhaust outlet 122, the purge valve 700, and the external outflow path 720 and are discharged out of the gas-liquid separation device 100.

For the purpose of size reduction, there is a narrow space between the gas-liquid separation device 100 and the hydrogen circulation pump 250 in the fuel cell system 1000 as shown in FIG. 2. In the fuel cell system 1000, the fuel gas outflow path 110 is arranged to differ in position in the direction perpendicular to the vertical direction from the separator 180 and the reservoir 190 in the gas-liquid separation device 100. This arrangement ensures the tool-manipulation space for allowing the user's manipulation of a tool (for example, a T wrench or an impact wrench) required for fastening the clamp bolts B1 at a specific position alongside the separator 180 or the reservoir 190 without being interfered with the separator 180 and the reservoir 190 as shown in FIG. 2. The flange 114 is thus readily fastened to the flange 254 even when there is only a narrow space between the gas-liquid separation device 100 and the hydrogen circulation pump 250. Namely this arrangement enables the fuel gas outflow path 110 to be readily connected with the hydrogen circulation pump 250.

In the gas-liquid separation device 100 of the fuel cell system 1000 of the embodiment, the fuel gas inlet 132 is arranged to be open in the y-direction, and the exhaust outlet 122 is arranged to be open in the direction opposite to the y-direction. Namely the fuel gas inlet 132 and the exhaust outlet 122 are arranged to be open in the opposite directions. This arrangement causes the inflow direction of the fuel gas via the fuel gas inlet 132 into the gas-liquid separation device 100 to be substantially equal to the outflow direction of the accumulated water via the exhaust outlet 122. The substantially equal inflow and outflow directions effectively prevent vortexes from being generated in the accumulated water discharged via the exhaust outlet 122, thus improving the water discharge property of the accumulated water via the exhaust outlet 122.

The gas-liquid separation device 100 of the embodiment is equivalent to the gas-liquid separation device in the claims of the invention. The separator 180 and the reservoir 190 of the embodiment respectively correspond to the separator and the reservoir in the claims of the invention. The fuel gas outflow path 110 of the embodiment is equivalent to either the fluid outflow path or the fuel gas outflow path in the claims of the invention. The fuel gas outlet 112 of the embodiment is equivalent to either the fluid outlet or the fuel gas outlet in the claims of the invention. The fuel gas supply conduit 204 of the embodiment corresponds to the fuel gas supply conduit in the claims of the invention. The hydrogen circulation pump 250 of the embodiment corresponds to either the pump or the connection object member in the claims of the invention. The fuel gas inlet 132 and the exhaust outlet 122 of the embodiment respectively correspond to the fuel gas inlet and the exhaust outlet in the claims of the invention. The flange 254 and the flange 114 of the embodiment respectively correspond to the first flange and the second flange in the claims of the invention. The clamp bolt B1 of the embodiment is equivalent to the clamp bolt in the claims of the invention.

### B. Second Embodiment

### B1. Structure of Gas-Liquid Separation Device 100A

A fuel cell system 1000A of a second embodiment has a similar configuration to that of the fuel cell system 1000 of the first embodiment, except that a gas-liquid separation device 100A is included in place of the gas-liquid separation device 100. The like constituents in the fuel cell system 1000A to those in the fuel cell system 1000 are expressed by the like numerals and are not specifically explained here. The following describes the detailed structure of the gas-liquid separation device 100A of the embodiment.

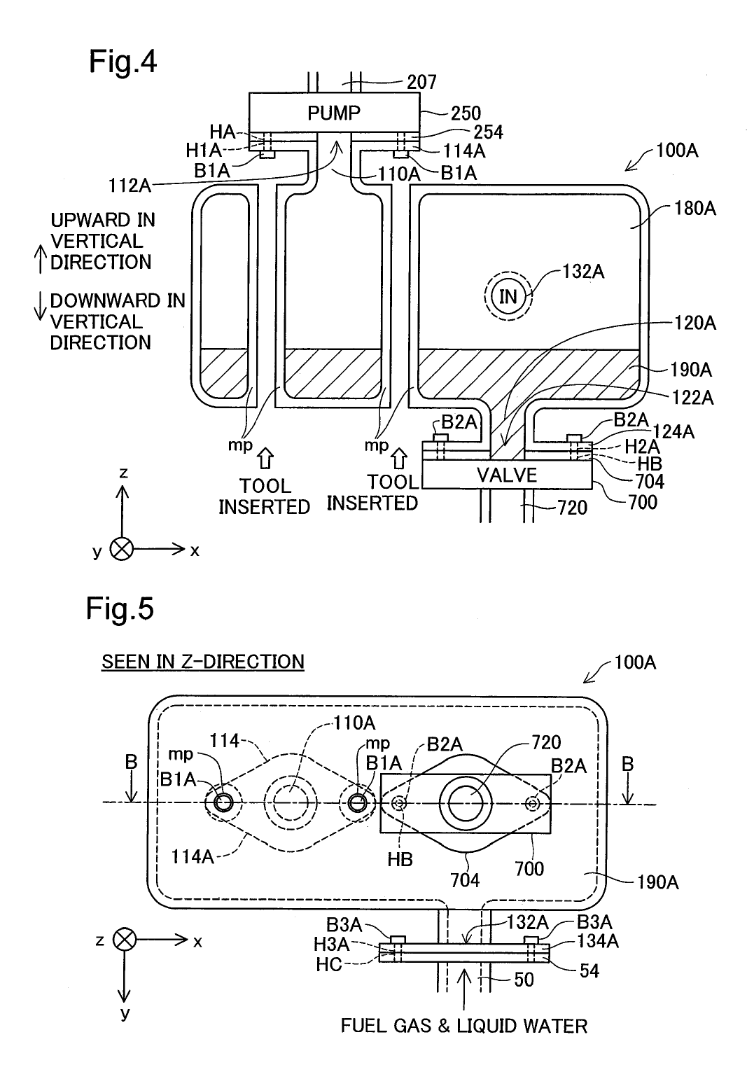

FIG. 4 schematically shows a cross section and periphery of the gas-liquid separation device 100A. An x-direction, a y-direction, and a z-direction are respectively defined as a horizontal direction, a front-back direction, and a vertical direction in FIG. 4. An upward direction and a downward direction in the drawing of FIG. 4 represent upward in a vertical direction (z-direction) and downward in the vertical direction (direction opposite to the z-direction). FIG. 5 shows the gas-liquid separation device 100A of FIG. 4 seen in the z-direction. The cross section of the gas-liquid separation device 100A shown in FIG. 4 is equivalent to a B-B cross section of FIG. 5.

The gas-liquid separation device 100A of this embodiment mainly includes a fuel gas inlet 132A, a fuel gas outflow path 110A, a gas discharge-water discharge flow path 120A, a separator 180A, a reservoir 190A, flanges 134A, 114A, and 124A, and hollow columns ‘mp’ as shown in FIGS. 4 and 5.

In the gas-liquid separation device 100A, the flange 134A is provided at the fuel gas inlet 132A. The flange 134A is fastened to the flange 54 provided in the fuel gas exhaust conduit 50 by means of clamp bolts B3A at two different positions. Such fixation connects the fuel gas inlet 132A with the fuel gas exhaust conduit 50 and thereby enables the fuel gas after the electrochemical reaction at the anodes of the fuel cell stack 900 to be introduced into the gas-liquid separation device 100A. Each of the clamp bolts B3A is inserted through a bolt hole H3A formed in the flange 134A and the bolt hole HC formed in the flange 54.

The separator 180A is designed to separate the fuel gas introduced via the fuel gas inlet 132A from the liquid water flowing with the fuel gas. The reservoir 190A is designed to allow accumulation of the liquid water separated by the separator 180A.

The fuel gas outflow path 110A is formed as a flow path of flowing out the fuel gas in the separator 180A toward the hydrogen circulation pump 250. As shown in FIGS. 4 and 5, the fuel gas outflow path 110A is extended upward in the vertical direction (z-direction). A fuel gas outlet 112A formed to be open upward in the vertical direction is provided at an end of the fuel gas outflow path 110A. The flange 114A is provided at the fuel gas outlet 112A. The flange 114A is fastened with the flange 254 provided in the hydrogen circulation pump 250 by means of clamp bolts B1A at two different positions. Such fixation connects the fuel gas outlet 112A with the hydrogen circulation pump 250. Each of the clamp bolts B1A is inserted through a bolt hole H1A formed in the flange 114A and the bolt hole HA formed in the flange 254A.

The gas discharge-water discharge flow path 120A is formed as a flow path of discharging the accumulated water in the reservoir 190A and the fuel gas out of the gas-liquid separation device 100A. As shown in FIGS. 4 and 5, the gas discharge-water discharge flow path 120A is extended downward in the vertical direction (z-direction) from the reservoir 190A.

An exhaust outlet 122A formed to be open downward in the vertical direction is provided at an end of the gas discharge-water discharge flow path 120A. The flange 124A is provided at the exhaust outlet 122A. The flange 124A is fastened to the flange 704 provided in the purge valve 700 by means of clamp bolts B2A at two different positions. Such fixation connects the exhaust outlet 122A with the purge valve 700. Each of the clamp bolts B2A is inserted through a bolt hole H2A formed in the flange 124A and the bolt hole HB formed in the flange 704.

The purge valve 700 is connected with the external outflow path 720. In an open position of the purge valve 700, the accumulated water inside the gas-liquid separation device 100 and the fuel gas having a relatively high concentration of impurities (for example, nitrogen) go through the gas discharge-water discharge flow path 120A, the exhaust outlet 122A, the purge valve 700, and the external outflow path 720 and are discharged out of the gas-liquid separation device 100.

The gas-liquid separation device 100A of this embodiment has the two hollow columns ‘mp’ as shown in FIGS. 4 and 5. Each of the hollow columns ‘mp’ is extended in the gas-liquid separation device 100A to have a hollow section connecting with outside of the gas-liquid separation device 100A and is formed to pass through the separator 180A and the reservoir 190A in the vertical direction (z-direction). The clamp bolts B1A to be inserted into the bolt holes H1A of the flange 114A are arranged on the extensions of the hollow sections. The hollow section of each hollow column ‘mp’ has an inner diameter that is greater than the outer diameter of the clamp bolt B1A. The hollow section of the hollow column ‘mp’ is not connected with the separator 180A or the reservoir 190A. This arrangement effectively prevents the fuel gas in the separator 180A or the accumulated water in the reservoir 190A from being leaked outside the gas-liquid separation device 100A via the hollow columns ‘mp’.

For the purpose of size reduction, there is a narrow space between the gas-liquid separation device 100A and the hydrogen circulation pump 250 in the fuel cell system 1000A as shown in FIG. 4. In the fuel cell system 1000A, the hollow columns ‘mp’ are extended in the gas-liquid separation device 100A to pass through the separator 180A and the reservoir 190A in the vertical direction. The clamp bolts B1A are arranged on the extensions of the hollow sections of the hollow columns ‘mp’. This arrangement enables a tool (for example, a T wrench or an impact wrench) required for fastening the clamp bolts B1A to be inserted into the hollow columns ‘mp’ and fasten the clamp bolts B1A. Namely the hollow sections of the hollow columns ‘mp’ are used as the tool-manipulation space to readily connect the fuel gas outflow path 110A with the hydrogen circulation pump 250 even when there is only a narrow space between the gas-liquid separation device 100A and the hydrogen circulation pump 250. The flange 114A is thus readily fastened to the flange 254. The hollow columns ‘mp’ provided in the gas-liquid separation device 100A desirably enhance the strength.

In the fuel cell system 1000A, the inner diameter of the hollow sections of the hollow columns ‘mp’ is greater than the outer diameter of the clamp bolts B1A. This arrangement facilitates insertion of the tool (for example, the T wrench or the impact wrench) required for fastening the clamp bolts B1A into the hollow columns ‘mp’, thus improving the assembling property.

The gas-liquid separation device 100A of the embodiment is equivalent to the gas-liquid separation device in the claims of the invention. The separator 180A and the reservoir 190A of the embodiment respectively correspond to the separator and the reservoir in the claims of the invention. The hollow column ‘mp’ of the embodiment corresponds to the hollow column in the claims of the invention. The fuel gas outflow path 110A and the fuel gas outlet 112A of the embodiment are respectively equivalent to the fuel gas outflow path and the fuel gas outlet in the claims of the invention. The hydrogen circulation pump 250 of the embodiment corresponds to either the pump or the connection object member in the claims of the invention. The flange 254 and the flange 114A of the embodiment respectively correspond to the first flange and the second flange in the claims of the invention. The clamp bolt B1A of the embodiment is equivalent to the clamp bolt in the claims of the invention.

### C. Third Embodiment

### C1. Structure of Gas-Liquid Separation Device 100B

A fuel cell system 1000B of a third embodiment has a similar configuration to that of the fuel cell system 1000A of the second embodiment, except that a gas-liquid separation device 100B is included in place of the gas-liquid separation device 100A. The like constituents in the fuel cell system 1000B or in the liquid-gas separation device 100B to those in the fuel cell system 1000A or in the liquid-gas separation device 100A are expressed by the like numerals and are not specifically explained here. The following describes the detailed structure of the gas-liquid separation device 100B of the embodiment.

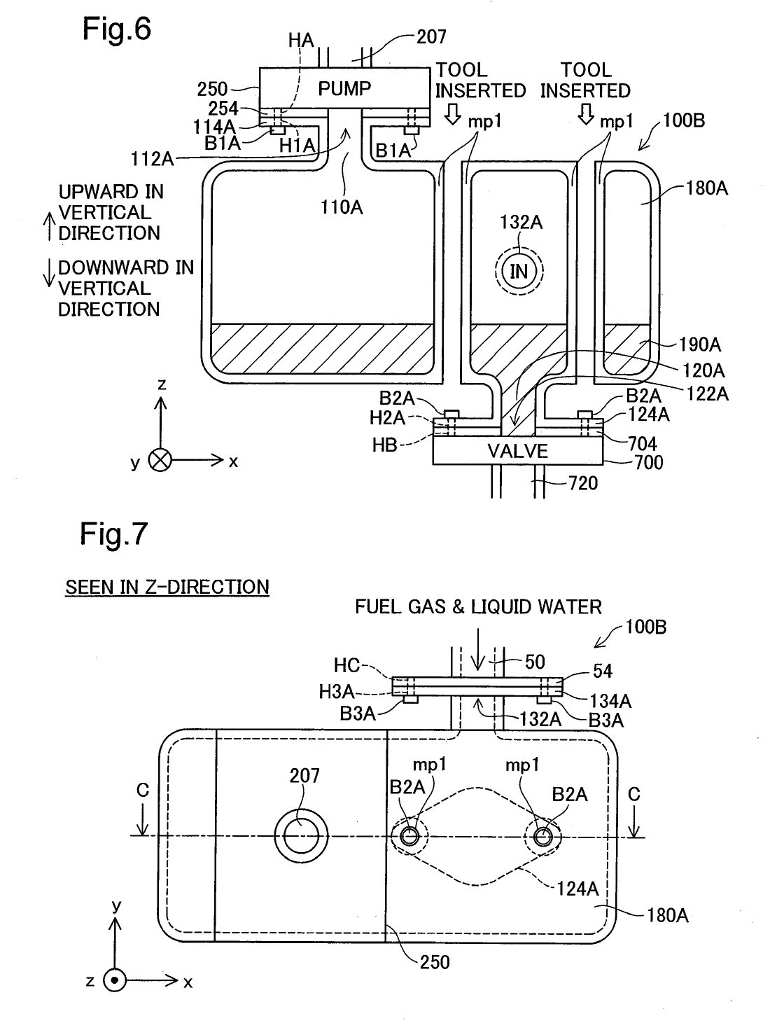

FIG. 6 schematically shows a cross section and periphery of the gas-liquid separation device 100B. An x-direction, a y-direction, and a z-direction are respectively defined as a horizontal direction, a front-back direction, and a vertical direction in FIG. 6. An upward direction and a downward direction in the drawing of FIG. 6 represent upward in a vertical direction (z-direction) and downward in the vertical direction (direction opposite to the z-direction). FIG. 7 shows the gas-liquid separation device 100B of FIG. 6 seen in the z-direction. The cross section of the gas-liquid separation device 100B shown in FIG. 6 is equivalent to a C-C cross section of FIG. 7.

As shown in FIGS. 6 and 7, the gas-liquid separation device 100B of the third embodiment has two hollow columns ‘mp1’ that are different from the hollow columns ‘mp’ included in the gas-liquid separation device 100A of the second embodiment. Each of the hollow columns ‘mp1’ is extended in the gas-liquid separation device 100B to have a hollow section connecting with outside of the gas-liquid separation device 100B and is formed to pass through the separator 180A and the reservoir 190A in the vertical direction (z-direction). The clamp bolts B2A to be inserted into the bolt holes H2A of the flange 124A are arranged on the extensions of the hollow sections. The hollow section of each hollow column ‘mp1’ has an inner diameter that is greater than the outer diameter of the clamp bolt B2A. The hollow section of the hollow column ‘mp1’ is not connected with the separator 180A or the reservoir 190A. This arrangement effectively prevents the fuel gas in the separator 180A or the accumulated water in the reservoir 190A from being leaked outside the gas-liquid separation device 100B via the hollow columns ‘mp1’.

For the purpose of size reduction, there is a narrow space between the gas-liquid separation device 100B and the purge valve 700 in the fuel cell system 1000B as shown in FIG. 6. In the fuel cell system 1000B, the hollow columns ‘mp1’ are extended in the gas-liquid separation device 100B to pass through the separator 180A and the reservoir 190A in the vertical direction. The clamp bolts B2A are arranged on the extensions of the hollow sections of the hollow columns ‘mp1’. This arrangement enables a tool (for example, a T wrench or an impact wrench) required for fastening the clamp bolts B2A to be inserted into the hollow columns ‘mp1’ and fasten the clamp bolts B2A. Namely the hollow sections of the hollow columns ‘mp1’ are used as the tool-manipulation space to readily connect the gas discharge-water discharge flow path 120A with the purge valve 700 even when there is only a narrow space between the gas-liquid separation device 100B and the purge valve 700. The flange 124A is thus readily fastened to the flange 704. The hollow columns ‘mp1’ provided in the gas-liquid separation device 100B desirably enhance the strength.

The gas-liquid separation device 100B of the embodiment is equivalent to the gas-liquid separation device in the claims of the invention. The separator 180A and the reservoir 190A of the embodiment respectively correspond to the separator and the reservoir in the claims of the invention. The hollow column ‘mp1’ of the embodiment corresponds to the hollow column in the claims of the invention. The gas discharge-water discharge flow path 120A and the purge valve 700 of the embodiment are respectively equivalent to the exhaust flow path and the connection object member in the claims of the invention. The flange 704 and the flange 124A of the embodiment respectively correspond to the first flange and the second flange in the claims of the invention. The clamp bolt B2A of the embodiment is equivalent to the clamp bolt in the claims of the invention.

### D. Fourth Embodiment

### D1. Structure of Gas-Liquid Separation Device 100C

A fuel cell system 1000C of a fourth embodiment has a similar configuration to that of the fuel cell system 1000A of the second embodiment, except that a gas-liquid separation device 100C is included in place of the gas-liquid separation device 100A. The like constituents in the fuel cell system 1000C or in the liquid-gas separation device 100C to those in the fuel cell system 1000A or in the liquid-gas separation device 100A are expressed by the like numerals and are not specifically explained here. The following describes the detailed structure of the gas-liquid separation device 100C of the embodiment.

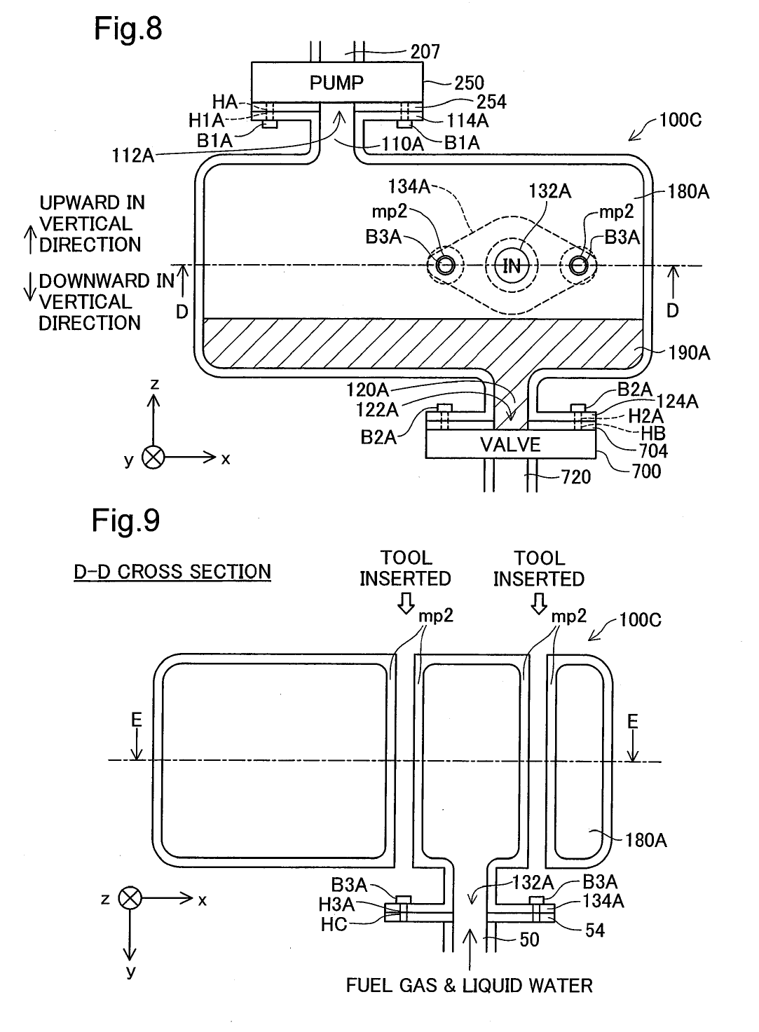

FIG. 8 schematically shows a cross section and periphery of the gas-liquid separation device 100C. An x-direction, a y-direction, and a z-direction are respectively defined as a horizontal direction, a front-back direction, and a vertical direction in FIG. 8. An upward direction and a downward direction in the drawing of FIG. 8 represent upward in a vertical direction (z-direction) and downward in the vertical direction (direction opposite to the z-direction). FIG. 9 shows a D-D cross section of the gas-liquid separation device 100C of FIG. 8. The cross section of the gas-liquid separation device 100C shown in FIG. 8 is equivalent to an E-E cross section of FIG. 9.

As shown in FIGS. 8 and 9, the gas-liquid separation device 100C of the fourth embodiment has two hollow columns ‘mp2’ that are different from the hollow columns ‘mp’ included in the gas-liquid separation device 100A of the second embodiment. Each of the hollow columns ‘mp2’ is extended in the gas-liquid separation device 100C to have a hollow section connecting with outside of the gas-liquid separation device 100C and is formed to pass through the separator 180A and the reservoir 190A in the front-back direction (y-direction) perpendicular to the vertical direction. The clamp bolts B3A to be inserted into the bolt holes H3A of the flange 134A are arranged on the extensions of the hollow sections. The hollow section of each hollow column ‘mp2’ has an inner diameter that is greater than the outer diameter of the clamp bolt B3A. The hollow section of the hollow column ‘mp2’ is not connected with the separator 180A or the reservoir 190A. This arrangement effectively prevents the fuel gas in the separator 180A or the accumulated water in the reservoir 190A from being leaked outside the gas-liquid separation device 100C via the hollow columns ‘mp2’.

In the fuel cell system 1000C, the hollow columns ‘mp2’ are extended in the gas-liquid separation device 100C to pass through the separator 180A and the reservoir 190A in the y-direction. The clamp bolts B3A are arranged on the extensions of the hollow sections of the hollow columns ‘mp2’. This arrangement enables a tool (for example, a T wrench or an impact wrench) required for fastening the clamp bolts B3A to be inserted into the hollow columns ‘mp2’ and fasten the clamp bolts B3A. Namely the hollow sections of the hollow columns ‘mp2’ are used as the tool-manipulation space to readily connect the gas-liquid separation device 100C (the fuel gas inlet 132A) with the fuel gas exhaust conduit 50 even when the fuel gas exhaust conduit 50 is very short and there is only a narrow space between the fuel cell stack 900 and the gas-liquid separation device 100C. The flange 134A is thus readily fastened to the flange 54. The hollow columns ‘mp2’ provided in the gas-liquid separation device 100C desirably enhance the strength.

The gas-liquid separation device 100C of the embodiment is equivalent to the gas-liquid separation device in the claims of the invention. The hollow column ‘mp2’ of the embodiment corresponds to the hollow column in the claims of the invention. The fuel gas inlet 132A and the fuel gas exhaust conduit 50 of the embodiment are respectively equivalent to the fuel gas inlet and the connection object member in the claims of the invention. The flange 54 and the flange 134A of the embodiment respectively correspond to the first flange and the second flange in the claims of the invention. The clamp bolt B3A of the embodiment is equivalent to the clamp bolt in the claims of the invention.

### E. Fifth Embodiment

### E1. Structure of Gas-Liquid Separation Device 100D

A fuel cell system 1000D of a fifth embodiment has a similar configuration to that of the fuel cell system 1000A of the second embodiment, except that a gas-liquid separation device 100D is included in place of the gas-liquid separation device 100A. The like constituents in the fuel cell system 1000D or in the liquid-gas separation device 100D to those in the fuel cell system 1000A or in the liquid-gas separation device 100A are expressed by the like numerals and are not specifically explained here. The following describes the detailed structure of the gas-liquid separation device 100D of the embodiment.

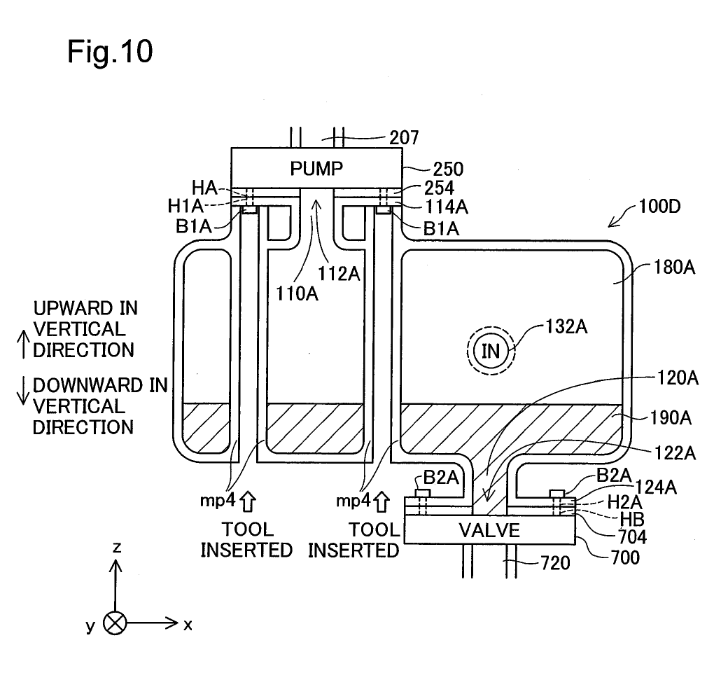

FIG. 10 schematically shows a cross section and periphery of the gas-liquid separation device 100D. An x-direction, a y-direction, and a z-direction are respectively defined as a horizontal direction, a front-back direction, and a vertical direction in FIG. 10. An upward direction and a downward direction in the drawing of FIG. 10 represent upward in a vertical direction (z-direction) and downward in the vertical direction (direction opposite to the z-direction). The sectional view of FIG. 10 corresponds to the sectional view of FIG. 4 showing the gas-liquid separation device 100A of the second embodiment.

As shown in FIG. 10, the gas-liquid separation device 100D of the fifth embodiment has two hollow columns ‘mp3’ that are slightly different from the hollow columns ‘mp’ included in the gas-liquid separation device 100A of the second embodiment. Each of the hollow columns ‘mp3’ is extended in the gas-liquid separation device 100D to have a hollow section connecting with outside of the gas-liquid separation device 100D and is formed to pass through the separator 180A and the reservoir 190A in the vertical direction (z-direction) and reach the flange 114A. The clamp bolts B1A to be inserted into the bolt holes H1A of the flange 114A are arranged on the extensions of the hollow sections. This arrangement desirably prevents a tool (for example, a T wrench or an impact wrench) inserted into the hollow columns ‘mp3’ for fastening the clamp bolts B1A from being misaligned from the clamp bolts B1A, thus improving the assembling property.

The hollow section of each hollow column ‘mp3’ has an inner diameter that is greater than the outer diameter of the clamp bolt B1A. The hollow section of the hollow column ‘mp3’ is not connected with the separator 180A or the reservoir 190A. This arrangement effectively prevents the fuel gas in the separator 180A or the accumulated water in the reservoir 190A from being leaked outside the gas-liquid separation device 100D via the hollow columns ‘mp3’.

The gas-liquid separation device 100E of the embodiment is equivalent to the gas-liquid separation device in the claims of the invention. The hollow column ‘mp3’ and the bolt hole H1A of the embodiment are respectively equivalent to the hollow column and the insertion structure in the claims of the invention. The flange 254 and the flange 114A of the embodiment respectively correspond to the first flange and the second flange in the claims of the invention. The clamp bolt B1A of the embodiment is equivalent to the clamp bolt in the claims of the invention.

### F. Other Aspects

Among the constituents of the respective embodiments described above, the constituents other than those claimed by the independent claims are additional elements and may be omitted when not required. The embodiments and their applications discussed above are to be considered in all aspects as illustrative and not restrictive. There may be many modifications, changes, and alterations without departing from the scope or spirit of the main characteristics of the present invention. Some examples of possible modification are given below.

### F1. Modified Example 1

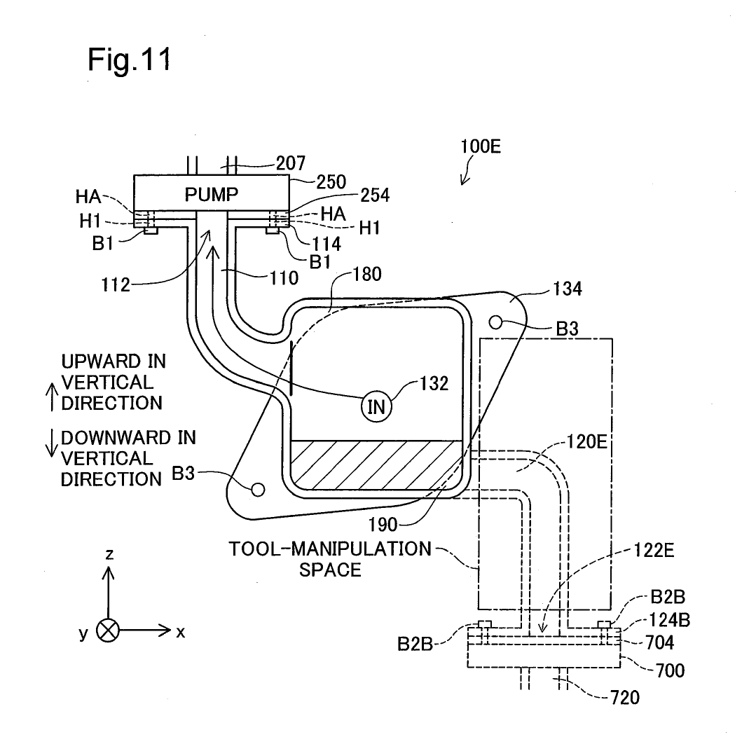

In the fuel cell system 1000 of the first embodiment, the exhaust outlet 122 is formed to be open in the direction opposite to the y-direction in the gas-liquid separation device 100. This arrangement is, however, neither essential nor restrictive. FIG. 11 schematically shows a cross section and periphery of a gas-liquid separation device 100E in a modified example 1. The sectional view of FIG. 11 corresponds to the sectional view of FIG. 2 showing the gas-liquid separation device 100 of the first embodiment. In the gas-liquid separation device 100E of FIG. 11, a gas discharge-water discharge flow path 120E is protruded from the reservoir 190 in the x-direction in a gently inclined manner and is bent downward in the vertical direction (direction opposite to the z-direction). An exhaust outlet 122E formed to be open downward in the vertical direction is provided at an end of the gas discharge-water discharge flow path 120E. This arrangement ensures the tool-manipulation space for allowing the user's manipulation of a tool (for example, a T wrench or an impact wrench) required for fastening clamp bolts B2B at a specific position alongside the separator 180 or the reservoir 190 without being interfered with the separator 180 and the reservoir 190 as shown in FIG. 11. The gas discharge-water discharge flow path 120E is thus readily connectable with the purge valve 700 even when there is only a narrow space between the gas-liquid separation device 100E and the purge valve 700. Namely a flange 124B provided in the exhaust outlet 122E is readily fastened to the flange 704. The gas discharge-water discharge flow path 120E of this modified example corresponds to the exhaust flow path or the fluid outflow path in the claims of the invention. The exhaust outlet 122E of this modified example corresponds to the exhaust outlet or the fluid outlet in the claims of the invention.

### F2. Modified Example 2

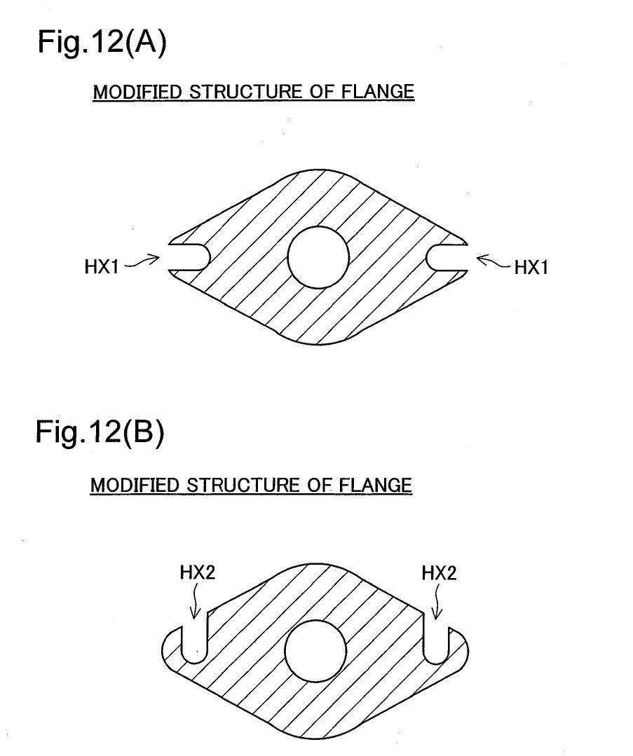

FIG. 12 shows modified structures of the flange included in the respective embodiments discussed above. In any of the fuel cell systems of the above embodiments, the flange used in the gas-liquid separation device may have two bolt holes HX1 formed as shown in FIG. 12(A). Each of the bolt holes HX1 is formed to be open in a thickness direction of the flange, as well as in a direction perpendicular to the thickness direction (that is, in a direction horizontal to the flange or in a flange plane direction). This modified structure enables clamp bolts to be inserted via the respective openings of the bolt holes HX1 in the flange plane direction and to be readily located at desired fastening positions in the respective bolt holes HX1. This arrangement desirably improves the assembling property of the flange with the clamp bolt. The bolt hole HX1 of this modified structure is equivalent to the insertion structure in the claims of the invention.

In any of the fuel cell systems of the above embodiments, the flange used in the gas-liquid separation device may have two bolt holes HX2 formed as shown in FIG. 12(B). Each of the bolt holes HX2 is formed to be open in the thickness direction of the flange, as well as in the direction perpendicular to the thickness direction (that is, in the flange plane direction). The two bolt holes HX2 opened in the flange plane direction have an identical opening orientation. This modified structure enables two clamp bolts to be inserted from one identical direction via the respective openings of the bolt holes HX2 opened in the same flange plane direction and to be quickly and readily located at desired fastening positions in the respective bolt holes HX2. This arrangement also desirably improves the assembling property of the flange with the clamp bolt. The bolt hole HX2 of this modified structure is equivalent to the insertion structure in the claims of the invention.

### F3. Modified Example 3

In the gas-liquid separation device 100A of the second embodiment, the fuel gas outflow path 110A is protruded from the separator 180A to be extended upward in the vertical direction (z-direction). The fuel gas outlet 112A is also formed to be open upward in the vertical direction. This arrangement is, however, neither essential nor restrictive. In one modified structure, the fuel gas outflow path 110A may be protruded from the separator 180A to be extended in a direction other than upward in the vertical direction (for example, in a direction (x-direction) perpendicular to the vertical direction). The fuel gas outlet 112A may be formed to be open in the extending direction of the fuel gas outflow path 110A. In this modified structure, the hollow columns ‘mp’ may also be formed to pass through the separator 180A and the reservoir 190A in the extending direction of the fuel gas outflow path 110A. The clamp bolts B1A to be inserted into the bolt holes H1A of the flange 114A are arranged on the extensions of the hollow sections of the hollow columns ‘mp’. This modified arrangement exerts the similar effects to those of the second embodiment.

### F4. Modified Example 4

The gas-liquid separation device 100A of the second embodiment may be further provided with either one or both of the hollow columns ‘mp 1’ of the third embodiment and the hollow columns ‘mp2’ of the fourth embodiment. Similarly the gas-liquid separation device 100B of the third embodiment may be further provided with either one or both of the hollow columns ‘mp’ of the second embodiment and the hollow columns ‘mp2’ of the fourth embodiment. The gas-liquid separation device 100C of the fourth embodiment may be further provided with either one or both of the hollow columns ‘mp’ of the second embodiment and the hollow columns ‘mp1’ of the third embodiment. In any of these modified structures, the hollow section of each hollow column is usable as the tool-manipulation space. This modified arrangement ensures size reduction of the fuel cell system and improves the strength of the gas-liquid separation device.

### F5. Modified Example 5

In the gas-liquid separation devices of the respective embodiments discussed above, the fuel gas exhaust conduit 50 may be omitted, and the fuel cell stack 900 may be configured to have a flange. The gas-liquid separation device may be connected with the fuel cell stack 900 by fastening the flange of the fuel cell stack 900 to a flange provided in a fuel gas inlet. This modified structure allows further size reduction of the fuel cell system. The fuel cell stack 900 of this modified example corresponds to the connection object member in the claims of the invention.

### F6. Modified Example 6

In the structures of the second through the fifth embodiments, the respective flanges are fastened by means of two clamp bolts. This arrangement is, however, neither essential nor restrictive. The respective flanges may be fastened by means of only one clamp bolt or by means of three or more clamp bolts. In this modification, the hollow columns may be formed corresponding to the number of clamp bolts. Even in the case of an increase in number of clamp bolts used for fastening the respective flanges, this modified arrangement ensures the tool-manipulation space for fastening the clamp bolts.

1. A gas-liquid separation device used in a fuel cell system including fuel cells, the gas-liquid separation device comprising:
a separator configured to separate a fuel gas after an electrochemical reaction performed in the fuel cells from water discharged with the fuel gas from the fuel cells;
a reservoir configured to allow accumulation of the water discharged from the fuel cells; and
a fluid outflow path arranged to connect the gas-liquid separation device with a connection object member, which is used in connection with the gas-liquid separation device, and have a fluid outlet formed to be open in a vertical direction and to differ in position in a direction perpendicular to the vertical direction from the separator and the reservoir, the fluid outflow path being configured to flow out a fluid from inside of the gas-liquid separation device to the connection object member via the fluid outlet.

2. The gas-liquid separation device in accordance with claim 1, wherein the fluid outflow path is constructed to function as a fuel gas outflow path and cause the fuel gas separated by the separator to be flowed out as the fluid upward in the vertical direction from the separator, and
the fluid outlet is formed to be open upward in the vertical direction and to function as a fuel gas outlet connecting with the connection object member.

3. The gas-liquid separation device in accordance with claim 2, wherein the fuel cell system includes:
a fuel gas supply conduit arranged to supply the fuel gas to the fuel cells; and
a pump arranged to recirculate the fuel gas, which is introduced into the gas-liquid separation device, to the fuel gas supply conduit for reuse, and
the fuel gas outlet of the fuel gas outflow path is connected with the pump functioning as the connection object member.

4. The gas-liquid separation device in accordance with claim 1, the gas-liquid separation device further having:
a fuel gas inlet formed to cause the fuel gas after the electrochemical reaction performed in the fuel cells to be introduced into the separator; and
an exhaust outlet formed to cause the accumulated water in the reservoir to be discharged out of the gas-liquid separation device,
wherein the fuel gas inlet and the exhaust outlet are arranged such as to make an inflow direction of the fuel gas via the fuel gas inlet into the gas-liquid separation device opposite to an outflow direction of the accumulated water via the exhaust outlet.

5. The gas-liquid separation device in accordance with claim 1, wherein the fluid outflow path is constructed as an exhaust flow path arranged to discharge the accumulated water in the reservoir downward in the vertical direction from the reservoir, and
the fluid outlet is formed to be open downward in the vertical direction and to function as an exhaust outlet connecting with the connection object member.

6. The gas-liquid separation device in accordance with claim 1, wherein the connection object member is designed to have a first flange provided at a connection structure of connecting the connection object member with the fluid outlet,
the gas-liquid separation device further having:
a second flange provided at the fluid outlet of the fluid outflow path,
wherein the connection object member is connected with the fluid outlet by fastening the first flange to the second flange with a clamp bolt.

7. A gas-liquid separation device used in a fuel cell system including fuel cells, the gas-liquid separation device comprising:
a separator configured to separate a fuel gas after an electrochemical reaction performed in the fuel cells from water discharged with the fuel gas from the fuel cells;
a reservoir configured to allow accumulation of the water discharged from the fuel cells; and
a hollow column extended to pass through either the separator or the reservoir and formed to have a hollow section connecting with outside of the gas-liquid separation device and a connection structure arranged on an extension of the hollow section to connect the gas-liquid separation device with a connection object member.

8. The gas-liquid separation device in accordance with claim 7, the gas-liquid separation device further having:
a fuel gas outflow path arranged to make the fuel gas separated by the separator flow out of the separator and formed to have a fuel gas outlet connecting with the connection object member,
wherein the hollow column is provided to locate a connection structure of connecting the fuel gas outlet of the fuel gas outflow path with the connection object member on the extension of the hollow section.

9. The gas-liquid separation device in accordance with claim 8, wherein the fuel gas outflow path is arranged to flow out the fuel gas upward in a vertical direction from the separator, and the fuel gas outlet is formed to be open upward in the vertical direction, and
the hollow column is extended to pass through either the separator or the reservoir in the vertical direction.

10. The gas-liquid separation device in accordance with claim 8, wherein the connection object member is designed to have a first flange provided at the connection structure of connecting the connection object member with the fuel gas outlet,
the gas-liquid separation device further having:
a second flange provided at the fuel gas outlet of the fuel path,
wherein the connection object member is connected with the fuel gas outlet by fastening the first flange to the second flange with a clamp bolt, and
the hollow column is arranged to locate the clamp bolt on the extension of the hollow section.

11. The gas-liquid separation device in accordance with claim 7, the gas-liquid separation device further having:
an exhaust flow path arranged to cause the accumulated water in the reservoir to be discharged from the reservoir and formed to have an exhaust outlet connecting with the connection object member,
wherein the hollow column is provided to locate a connection structure of connecting the exhaust outlet of the exhaust flow path with the connection object member on the extension of the hollow section.

12. The gas-liquid separation device in accordance with claim 11, wherein the connection object member is designed to have a first flange provided at a connection structure of connecting the connection object member with the exhaust outlet,
the gas-liquid separation device further having:
a second flange provided at the exhaust outlet of the fuel exhaust flow path,
wherein the connection object member is connected with the exhaust outlet by fastening the first flange to the second flange with a clamp bolt, and
the hollow column is formed to locate the clamp bolt on the extension of the hollow section.

13. The gas-liquid separation device in accordance with claim 7, the gas-liquid separation device further having:
a fuel gas inlet formed to cause the fuel gas after the electrochemical reaction performed in the fuel cells to be introduced into the separator,
wherein the hollow column is provided to locate a connection structure of connecting the fuel gas inlet with the connection object member on the extension of the hollow section.

14. The gas-liquid separation device in accordance with claim 13, wherein the connection object member is designed to have a first flange provided at a connection structure of connecting the connection object member with the fuel gas inlet,
the gas-liquid separation device further having:
a second flange provided at the fuel gas inlet,
wherein the connection object member is connected with the fuel gas inlet by fastening the first flange to the second flange with a clamp bolt, and
the hollow column is formed to locate the clamp bolt on the extension of the hollow section.

15. The gas-liquid separation device in accordance with claim 10, wherein the second flange is designed to have an insertion structure formed to receive the clamp bolt inserted therein, and
the hollow column is connected with the second flange, and the hollow section of the hollow tube communicates with the insertion structure of the second flange.

16. The gas-liquid separation device in accordance with claim 10, wherein the second flange is designed to have an insertion structure formed to receive the clamp bolt inserted therein, and
the insertion structure is formed to be open in a thickness direction of the second flange, as well as in a direction perpendicular to the thickness direction.

17. The gas-liquid separation device in accordance with claim 16, wherein the second flange is designed to have at least two insertion structures, and
the insertion structures are formed to be open in the thickness direction of the second flange, as well as in the direction perpendicular to the thickness direction and are arranged to have an identical opening orientation in the direction perpendicular to the thickness direction.

18. The gas-liquid separation device in accordance with claim 10, wherein the hollow section of the hollow column is formed to have an inner diameter that is greater than an outer diameter of the clamp bolt.

19. The gas-liquid separation device in accordance with claim 7, wherein the connection object member is a pump.

20. A fuel cell system equipped with the gas-liquid separation device in accordance with claim 1.
